(19) United States
(12) Patent Application Publication
(10) Pub. No.: US 2003/0214746 A1
(43) Pub. Date: Nov. 20, 2003

(54) Active disk locking system in a disk drive using shape memory alloy

(76) Inventors: Dong-Ho Oh, San Jose, CA (US); Seong-Woo Kang, Santa Clara, CA (US); Yun-Sik Han, Santa Clara, CA (US); Tae-Yeon Hwang, San Jose, CA (US); Myeong-Eop Kim, Santa Clara, CA (US)

Correspondence Address: IRELL & MANELLA LLP, 840 NEWPORT CENTER DRIVE, SUITE 400, NEWPORT BEACH, CA, 92660, US

(21) Appl. No.: 10/146,017

(22) Filed: May 14, 2002

(51) Int. Cl. G11B 15/48; G11B 19/02; G11B 5/012

(52) U.S. Cl. 360/74.1; 360/69; 360/97.01

(57) ABSTRACT

A hard disk drive that has a locking actuator which can engage and lock a disk and spindle motor of the drive. The locking actuator may have a shape memory alloy element that causes a plunger to engage and lock a disk(s) when power is terminated to the drive. In the locked position the actuator can minimize the impact of shock and vibration loads on the spindle motor, particularly when the hard disk drive is shipped and transported. The shape memory alloy element is heated when the hard disk drive receives power. The heated shape memory alloy element disengages the plunger from the disk and allows for operation of the disk drive.

### BACKGROUND OF THE INVENTION

1. Field of the Invention

The subject matter disclosed generally relates to the field of hard disk drives.

2. Background Information

Hard disk drives contain a plurality of magnetic heads that are coupled to rotating disks. The heads write and read information by magnetizing and sensing the magnetic fields of the disk surfaces. There have been developed magnetic heads that have a write element for magnetizing the disks and a separate read element for sensing the magnetic fields of the disks. The read element is typically constructed from a magneto-resistive material. The magneto-resistive material has a resistance that varies with the magnetic fields of the disk. Heads with magneto-resistive read elements are commonly referred to as magneto-resistive (MR) heads.

Each head is attached to a flexure beam to create an subassembly commonly referred to as a head gimbal assembly (“HGA”). The HGA's are attached to an actuator arm that has a voice coil coupled to a magnet assembly. The voice coil and magnet assembly create a voice coil motor that can pivot the actuator arm and move the heads across the disks.

Information is typically stored within annular tracks that extend across each surface of a disk. The voice coil motor can move the heads to different track locations to access data stored onto the disk surfaces. Each track is typically divided into a plurality of adjacent sectors. Each sector may have one or more data fields. Each data field has a series of magnetic transitions that are decoded into binary data. The spacing between transitions define the bit density of the disk drive.

The disks are rotated by a spindle motor that is mounted to a base plate of the disk drive. The disk drive may be subjected to shock and vibration loads during shipping and handling. The shock and vibration loads may damage components within the drive. For example, the spindle motor bearing contains a ball or groove that may become damaged. The damaged bearings may increase audible noise of he drive and also create undesirable disk runout. Disk runout decreases the access time of the heads and decreases the performance of the drive.

### BRIEF SUMMARY OF THE INVENTION

A hard disk drive that includes a locking actuator that can engage and lock a disk of the drive.

### BRIEF DESCRIPTION OF THE DRAWINGS

FIG. 1 is a top view of a hard disk drive;

FIG. 2 is a top enlarged view of a locking actuator of the disk drive in an actuated state;

FIG. 3 is a top view of the locking actuator in a de-actuated state;

FIG. 4 is a top view of an alternate embodiment of a locking actuator in an actuated state;

FIG. 5 is a top view of the locking actuator shown in FIG. 4 in a de-actuated state.

### DETAILED DESCRIPTION

Disclosed is a hard disk drive that has a locking actuator which can engage and lock a disk and spindle motor of the drive. The locking actuator may have a shape memory alloy element that causes a plunger to engage and lock a disk(s) when power is terminated to the drive. In the locked position the actuator can minimize the impact of shock and vibration loads on the spindle motor, particularly when the hard disk drive is shipped and transported. The shape memory alloy element is heated when the hard disk drive receives power. The heated shape memory alloy element disengages the plunger from the disk and allows for operation of the disk drive. Once the shape memory alloy element is heated and the plunger disengages from the disk(s), current to the shape memory alloy element may be terminated, if the temperature within the disk drive is high enough to maintain the shape memory alloy material in the austenite phase.

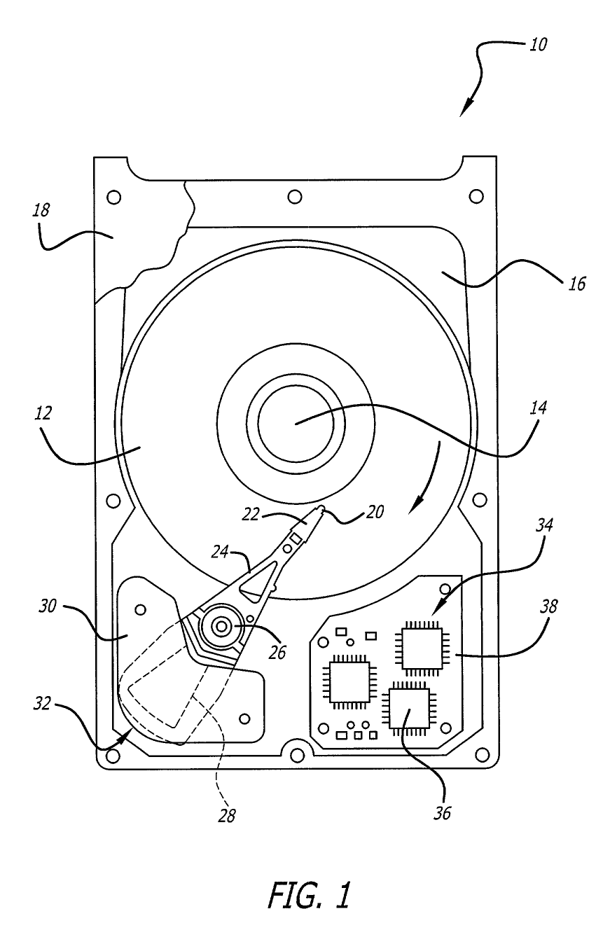

Referring to the drawings more particularly by reference numbers, FIG. 1 shows an embodiment of a hard disk drive 10. The disk drive 10 may include one or more magnetic disks 12 that are rotated by a spindle motor 14. The spindle motor 14 may be mounted to a base plate 16. The disk drive 10 may further have a cover 18 that encloses the disks 12.

The disk drive 10 may include a plurality of heads 20 located adjacent to the disks 12. The heads 20 may have separate write and read elements (not shown) that magnetize and sense the magnetic fields of the disks 12.

Each head 20 may be gimbal mounted to a flexure beam 22 as part of a head gimbal assembly (HGA). The flexure beams 22 are attached to an actuator arm 24 that is pivotally mounted to the base plate 16 by a bearing assembly 26. A voice coil 28 is attached to the actuator arm 24. The voice coil 28 is coupled to a magnet assembly 30 to create a voice coil motor (VCM) 32. Providing a current to the voice coil 28 will create a torque that swings the actuator arm 24 and moves the heads 20 across the disks 12.

Each head 20 has an air bearing surface (not shown) that cooperates with an air flow created by the rotating disks 12 to generate an air bearing. The air bearing separates the head 20 from the disk surface to minimize contact and wear. The formation of the air bearing and the general operation of the head 20 is a function of a force exerted by the flexure beam 22.

The hard disk drive 10 may include a printed circuit board assembly 34 that includes a plurality of integrated circuits 36 coupled to a printed circuit board 38. The printed circuit board 38 is coupled to the voice coil 28, heads 20 and spindle motor 14 by wires (not shown).

The hard disk drive 10 includes a locking actuator 40 that can engage and lock the disk 12. Locking the disk 12 also secures the spindle motor 14 and prevents damage to the motor 14 when the disk drive 10 is shipped and transported. The locking actuator 40 is connected to the printed circuit board assembly 34. The circuit board assembly 34 can provide electrical current to control the locking actuator 40.

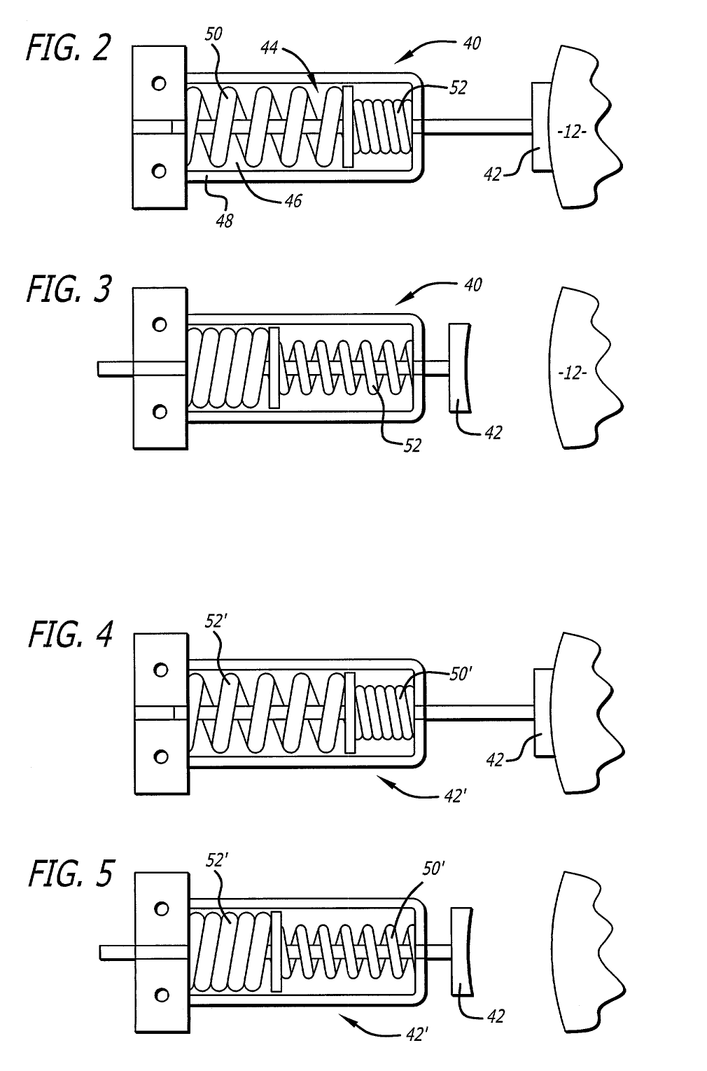

FIG. 2 shows an embodiment of a locking actuator 40 that has a plunger 42 which can be pressed against the disk 12. The plunger 42 is coupled to a spring assembly 44 located within a cavity 46 of a actuator housing 48. The housing 48 may be mounted to the base plate 16. The spring assembly 44 may include a biasing spring 50 that biases the plunger 42 into the disk 12 and a shape memory alloy element 52 that can push the plunger 42 away from the disk 12. The element 52 may be shaped as a spring. The shape memory alloy (“SMA”) element 52 is connected to the printed circuit board assembly 34 which can provide current to heat the element 52. The element 52 is constructed from a material that changes shape in response to a change in temperature. Such materials are well known in the art.

When the disk drive 10 has no power, there is no current provided to the SMA element 52. The SMA element 52 is in a compressed martensite phase wherein the biasing spring 50 pushes the plunger 42 into the disk 12. The spring force of spring 50 is sufficient to lock in the position of the disk 12 and the spindle motor 14. This prevents relative disk 12 and motor 14 movement during shipping and handling of the disk drive.

When the disk drive 10 receives power, current is provided to the SMA element 52. The current heats the SMA element 52 and causes the SMA material to transition to an austenite phase. The phase transition causes the element 52 to expand and push the plunger 42 away from the disk 12. The plunger 42 remains disengaged from the disk 12 during the operation of the disk drive 10. Once the SMA element 52 is heated and the plunger 42 disengages from the disk 12, current to the element 52 may be terminated, if the temperature within the disk drive is high enough to maintain the SMA material in the austenite phase. When power is again terminated to the drive 10, the element 52 contracts and the plunger 42 re-engages the disk 12.

FIGS. 4 and 5 show another embodiment of a locking actuator 42′ where the SMA element 52′ and biasing spring 50′ have been reversed. In this embodiment, the SMA element 52′ pushes the plunger 42 into the disk 12 when the disk drive is without power. During operation of the drive 10, the SMA element 52′ is heated and changes to a compressed shape. This allows the biasing spring 50′ to push the plunger 42 away from the disk 12.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

For example, although a locking actuator 40 with SMA material is shown and described, it is to be understood that the actuator 40 may have a different type of actuating device. The locking actuator 40 may contain a solenoid or some other mechanism that moves the plunger 42 away from the disk 12 when the disk drive 10 is operating, and pushes the plunger 42 into the disk 12 when power to the drive 10 is terminated.

What is claimed is:

1. A hard disk drive, comprising:
a base plate;
a spindle motor coupled to said base plate;
a disk coupled to said spindle motor;
an actuator arm mounted to said base plate;
a voice coil motor coupled to said actuator arm;
a flexure beam coupled to said actuator arm;
a head coupled to said flexure beam and said disk; and,
a locking actuator that is attached to said base plate and coupled to said disk.

2. The hard disk drive of claim 1, wherein said locking actuator includes a shape memory alloy element.

3. The hard disk drive of claim 2, wherein said shape memory alloy element is in tension when said locking actuator locks said disk.

4. The hard disk drive of claim 2, wherein said shape memory alloy element is in compression when said locking actuator locks said disk.

5. The hard disk drive of claim 2, wherein said locking actuator includes a plunger and a biasing spring coupled to said shape memory alloy element, said plunger engages and locks said disk.

6. A hard disk drive, comprising:
a base plate;
a spindle motor coupled to said base plate;
a disk coupled to said spindle motor;
an actuator arm mounted to said base plate;
a voice coil motor coupled to said actuator arm;
a flexure beam coupled to said actuator arm;
a head coupled to said flexure beam and said disk; and,
a locking actuator that has a shape memory alloy element coupled to a plunger that can engage and lock said disk.

7. The hard disk drive of claim 6, wherein said shape memory alloy element is in tension when said plunger locks said disk.

8. The hard disk drive of claim 6, wherein said shape memory alloy element is in compression when said plunger locks said disk.

9. The hard disk drive of claim 6, wherein said locking actuator includes a biasing spring coupled to said shape memory alloy element and said plunger.

10. A hard disk drive, comprising:
a base plate;
a spindle motor coupled to said base plate;
a disk coupled to said spindle motor;
an actuator arm mounted to said base plate;
a voice coil motor coupled to said actuator arm;
a flexure beam coupled to said actuator arm;
a head coupled to said flexure beam and said disk; and,
locking means for locking said disk.

11. The hard disk drive of claim 10, wherein said locking means includes a shape memory alloy element.

12. The hard disk drive of claim 11, wherein said shape memory alloy element is in tension when said locking means locks said disk.

13. The hard disk drive of claim 11, wherein said shape memory alloy element is in compression when said locking means locks said disk.

14. The hard disk drive of claim 11, wherein said locking actuator includes a plunger and a biasing spring coupled to said shape memory alloy element, said plunger engages and locks said disk.

15. A method for locking a disk of a hard disk drive, comprising:
switching a locking actuator to engage and lock a disk.

16. The method of claim 15, wherein the locking actuator is switched by heating a shape memory alloy element.

17. The method of claim 15, wherein the locking actuator is switched when power to the hard disk drive is terminated.

18. The method of claim 17, wherein the locking actuator is switched again to disengage and unlock the disk when power is provided to the hard disk drive.
